(19) United States
(12) Patent Application Publication
(10) Pub. No.: US 2019/0027056 A1
(43) Pub. Date: Jan. 24, 2019

(54) Learning Edition

(71) Applicants: Liam Desmond Kiara, New York, NY (US); Eileen Bernstein, Youngville, NY (US); Barbra Lund, Newton, MA (US)

(72) Inventors: Liam Desmond Kiara, New York, NY (US); Eileen Bernstein, Youngville, NY (US); Barbra Lund, Newton, MA (US)

(21) Appl. No.: 15/656,189

(22) Filed: Jul. 21, 2017

(51) Int. Cl. G09B 17/00

(52) U.S. Cl. CPC G09B 17/00

(57) ABSTRACT

A method of rapidly learning the meaning of unfamiliar words and concepts in all forms of reading material.

### (1) BACKROUND OF THE INVENTION

While I, Liam D. Kiara, was reading the book “Look Homeward Angle” by Thomas Wolf, I became upset at having to stop my reading to go to a dictionary and or a far off encyclopedia to learn the meaning of so many words and concepts contained in that book that I did not know the meaning of. Having to do so, I interrupted my train of thought and my understanding of the book.

I thought, wouldn't it be nice if knew the meaning of all the words and concepts contained in a chapter of a book before I read that chapter.

I underlined all the words and concepts I did not know the meaning of in the next chapter of “Look Homeward Angle.”

I then complied those words and concepts into a Focused Micro Dictionary-Encyclopedia and placed that source of information in the book just before that next chapter.

Using this near-by Focused Micro Dictionary-Encyclopedia, I was able to easily look up and learn the meaning of the elusive words and concepts. With that accomplished, I was then able to turn my full attention to the reading thereby, getting a deeper understanding of what I was reading.

A short time later, I decided to add a test page, testing myself to ensure that I learned meaning of all the words and concepts that I set out to learn.

Using my invention, I got a deeper understanding of not only of each chapter but also of the entire book, way beyond just knowing the meaning of each individual word and each individual concept.

### (2) BRIEF SUMMARY OF THE INVENTION

Using my invention, a text, whether it be in book, journal, magazine, newspaper, paragraph, article, sentence, poetry or research form, is formatted so that one can know the meaning of all the words and concepts contained in that text before they are encountered in the reading of that text.

A focused micro dictionary-encyclopedia is placed at the beginning of each chapter-text. (Example: Dictionary 39 precedes Chapter 39)

Each focused micro dictionary-encyclopedia contains only those words one may not know the meaning of, that appear in the chapter-text that follows it.

Learning the meaning of these words prior to encountering them in the text allows one to read the text without interruption.

Having the focused micro dictionary-encyclopedia easily available, one can comfortably separate the research from the reading.

First the research; then the knowledgeable reading.

Not having to stop and do research while reading, allows one to more easily access the meaning, experience, the insight and the poetry contained in the text.

### (4) DETAILED DESCRIPTION OF THE INVENTION

A standard edition of a book-text is converted into a learning edition of the book-text by making the following changes:
1. The words ”Learning Edition” is added to the title page.
2. Words in the text of the book-text that need defining or explaining are marked.
3. A page of instruction titled “Learning Edition” * is placed just after the title page.
4. A different Focused Micro Dictionary-Encyclopedia** is placed before each chapter-text composed of only those words that appear in each chapter-text that need defining.
5. A test page ***, when necessary, is placed just after the dictionary,

### Learning Edition

This book-text is formatted so that you can know the meaning of all the words-concepts before you encounter them in the book-text.

A focused micro dictionary-encyclopedia is placed before each chapter-text.

Each specific Focused Micro Dictionary-Encyclopedia contains only those words that you may not be familiar with that occur in each specific chapter-text.

These words are marked in the text of each chapter-text.

Learning the meaning of these selected words-concepts prior to encountering them in the chapter text allows you to read the chapter-text without interruption.

Having the focused micro dictionary-encyclopedia easily available, you can separate the research from the knowledge-able reading.

Not having to stop and do research while reading; allows you to more easily access the experience, the insight and the poetry contained in the chapters-text.
Before publication have a group of average readers, read the proofs of the new or reissued book-text and have each person mark the words or concepts they do not know the meaning of or have the author or an editor mark those words the author or editor think the average reader may not be familiar with.
Using these selected words, create Focused Micro Dictionary-Encyclopedias and place these Focused Micro Dictionary Encyclopedia before each chapter-text.
Using these Focused Micro Dictionaries Encyclopedias have the average readers study the meaning of the words-concepts they do not know the meaning of prior to reading the text.

When the average reader thinks they know the meaning of the words-concepts in the Focused Micro Dictionary-Encyclopedia, they can test themselves, using the test page* provided.
When the average reader learns the meaning of all the words-concepts in a specific Focused Micro Dictionary-Encyclopedia, they can go on to read that Chapter text without interruption.
Using my invention, again go on to the next chapter-text.
Using my invention allows you to not only to easily learn the meaning of unfamiliar words and concepts, having the focused micro dictionary-encyclopedia so close by, but it also allows you, by reading a chapter-text without Interruption to get a greater understanding of the book-text itself.

Test Page (When Necessary)
Consists of a list of the selected words in random order without their definitions but with a place for the reader to write in the learned definition.

1. We claim this invention easily separates the learning of unfamiliar vocabulary and concepts from the reading of the text that contain these words and concepts by making the following alterations to a standard text;
adding, below the title, the words “Learning Edition,”
that include, before the text, adding instructions explaining how to use the “Learning Edition,”
that include marking in the text, the words and concepts that need defining,
that include including a focused micro dictionary-encyclopedia before each chapter-paragraph containing only those words that need defining in that chapter-paragraph,
that include including a test page when necessary;
by having learned the meaning of all the words contained in the text prior to reading the text allows one to read the text without interruption thereby getting easy access the meaning, the experience, the insight, and the poetry contained in the text.
